(19) United States
(12) Patent Application Publication
(10) Pub. No.: US 2006/0069698 A1
(43) Pub. Date: Mar. 30, 2006

(54) Method and arrangement for editing and displaying information

(75) Inventor: Antti Hintikka, Haukipudas (FI)

Correspondence Address: YOUNG & THOMPSON, 745 SOUTH 23RD STREET, 2ND FLOOR, ARLINGTON, VA, 22202, US

(73) Assignee: TARGETOR OY, OULU (FI)

(21) Appl. No.: 11/267,253

(22) Filed: Nov. 7, 2005

Related U.S. Application Data
(63) Continuation of application No. PCT/FI04/00275, filed on May 7, 2004.

(30) Foreign Application Priority Data
May 7, 2003 (FI) 20030684

(51) Int. Cl. G06F 17/00

(52) U.S. Cl. 707/102

(57) ABSTRACT

A method for processing information in an electronic information system, which includes a database for saving the information produced by the users in a centralized manner, and a user-specific graphic user interface for presenting the information on least two different viewing sides and for retrieving information from the database and for recording it in the database by the user, in which method the information of the database is linked to at least two different viewing sides, a point of view to be associated with the information to be saved in the database is formed, which point of view specifies at least one characteristic of the creator of the information, the viewing side and the point of view are selected by the user, and the information of the selected viewing side is retrieved from the database and the information is filtered on the basis of the selected point of view.

### TECHNICAL FIELD OF THE INVENTION

The present invention relates to a method and arrangement for editing and displaying information particularly, but not necessarily, in business development processes.

### BACKGROUND OF THE INVENTION

More and more economic resources of companies are nowadays used for developing business operations and drawing up strategies. In addition, they tie up the resources of employees in companies.

In organisations that are decentralized to many localities, a lot of travelling takes place merely because of meetings, examples of which include brainstorming, strategy meetings and other strategy-related communication, such as roadmapping. Travelling is expensive, time-consuming and not desirable for reasons of safety.

The working hours saved for the topmost management in the form of reduced travelling is a critical competition factor. One strategic round creates the need to travel for participating in 2-5 meetings. The costs of mere domestic travel can be as much as 8000 to 10000 [symbol] per meeting even in a small group. In intercontinental flights, the costs easily rise 5 to 8 times higher.

It is often difficult, even impossible to understand the other party's point of view. Commitment to a strategy, implementing a strategy and committing oneself to it is even more challenging. Therefore, various tools are needed for understanding the point of view of a person or a unit of an organisation. One possibility in this work is to describe the matter being considered by means of the points of view of the persons or units of an organisation.

One example of a prior art electronic teamwork system functioning in an information network is Ryhmix, the presentation of which is found in the address www.internetix.fi. The user tools allowed for different user groups are specified in Ryhmix. The functions of Ryhmix include a discussion forum, group mail and linking information. The use of Ryhmix is based on selection links and buttons on its different pages. Proceeding and returning from one page of Ryhmix to another requires for the user to perceive the created unity in order to avoid trial-and-error-like operation.

One example of the use of a point of view in the filtering of information is in the publication Billsus, Pazzani: “Learning collaborative information filters”, Proceedings 15th International Conference on Machine Learning, pages 46-54.

The prior art systems thus often provide a possibility for distributed working. However, most of them lack the possibility of working on documents simultaneously. The point of view determination is not utilized in them. The feedback information received from different customer segments cannot be utilized in real time, either. In addition, the present prior art systems are expensive.

### SUMMARY OF THE INVENTION

The new method and arrangement introduced now relate to various business development processes. The business process to be developed could be, for example, the whole strategic process or a part thereof, the development process of a starting new company, or the product development process carried out in connection with bringing a new product on the market. The basic characteristic of the invention is to support the communication and dialogue between people and units in the development process. The invention supports a decentralized dialogue in the form of reports, feedback and commenting between the business management and business units and directly between different business units already during the development process. Dealing with matters from different points of view utilizing the metaphor “it depends on from where you look” during the process in its different steps is essential for creating a common outlook. Due to a user interface based on the preferably three-dimensional computer graphics according to the invention, perceiving entities and looking at matters from different directions and points of view becomes easy and understandable for the user. In the arrangement according to the invention, the user can bring out the desired perspective by means of a 3D user interface. Various links or buttons are not needed for proceeding.

The method implemented according to the first aspect of the invention for processing information in an electronic information system comprises a database for saving the information produced by the users in a centralized manner, and a user-specific, graphic 3D user interface for presenting information on at least two different viewing sides and for retrieving information from the database and taking information to the database. The method according to the invention is characterized in that in the method the information of the database is linked to at least two different viewing sides, a point of view is formed to be associated with the information to be saved in the database, which point of view specifies at least one characteristic of the creator of the information, a viewing side and point of view are selected by the user, and the information of the selected viewing side is retrieved from the database and said information is filtered on the basis of the selected point of view.

An electronic information system implemented according to another aspect of the invention comprises a database for saving the information produced by the users in a centralized manner and a user-specific, graphic 3D user interface for presenting information on at least two different viewing sides and for retrieving information from the database and taking information to the database by the user. The arrangement according to the invention is characterized in that the arrangement comprises linking means for linking the information of the database to at least two different viewing sides, forming means for forming a point of view in the information to be saved in the database, which point of view specifies at least one characteristic of the creator of the information, offering means for offering at least one viewing side and at least one point of view to the user through a 3D user interface, retrieving means for retrieving the information of the selected viewing side from the database, and filtering means for filtering said information on the basis of the point of view selected by the user.

A computer program product implemented according to a third aspect of the invention for an electronic information system, which comprises at least one electronic device, which further comprises a database for saving the information produced by the users in a centralized manner, and a graphic 3D user interface for presenting the information on at least two different viewing sides and for retrieving information from the database and taking information to the database by the user. The computer program product according to the invention is characterized in that the computer program product comprises computer program means for linking the information of the database to at least two different viewing sides, computer program means for creating a point of view in the information to be saved in the database, which point of view specifies at least one characteristic of the creator of the information, computer program means for offering at least one viewing side and at least one point of view to the user through the user interface, and computer program means for retrieving the information of the selected viewing side from the database, and computer program means for filtering said information on the basis of the point of view selected by the user.

The invention has the advantage that by means of the 3D user interface, turning the navigator of the user interface, the user can easily bring out the desired point of view to the matter under consideration.

Furthermore, the invention has the advantage that the user can view the matter selected through the point of view also selected by the user, which point of view filters out from the existing information the information that does not belong to the point of view selected. Only the information belonging to the perspective according to the point of view is presented.

In addition, the advantages brought by the method and arrangement according to the invention include a reduced need for travelling, getting acquainted with the point of view of another interest group in a user-friendly manner, easier implementation of the development needs arisen, and bringing help to communication challenges. In addition, by means of the invention it is possible to utilize real-time feedback information received from different customer groups or of different products in different business development processes.

The method and arrangement operate over the communication network by means of a mobile terminal device, for example, whereby decentralized working, dialogue and commenting from the working stations of the participants of the common session is possible, as well as it is also possible to collect and utilize customer feedback in real time. The specification of the point of view, dialogue and decentralized functionality are included in the same tool.

The implementation according to the invention is suitable for being integrated into the existing systems of organisations and into software tools already used by the personnel, in which case the applicability to the operating models of different organisations is good. The flexibility and general structure of the procedure according to the invention makes it possible to apply and utilize it in the information collection, development and communication of the development work of the business operations of different organisations. The operation of a geographically decentralized organisation becomes more efficient, because the development work can be carried out by working independently of the time and place on the levels of both individual and group work, supporting the operation models of decentralized organisations and intensifying the development work between units. It is especially advantageous that the real-time customer feedback is also automatically updated to the arrangement according to the invention in such a form that it is useful in development work.

Achieving the objectives does not require the creation of technical system solutions that are new from the technological point of view, or new middleware, but above all the utilization and integration of the existing systems, interfaces and middleware in a new way.

The basic idea of the invention is to utilize 3-dimensional computer graphics to illustrate the communication and dialogue between the interest groups. Utilizing standardized Internet technologies also in the application development of the product makes it possible for the users to take the product into use easily and use it in the manner of application leasing and web browsing. The users need not go through a strenuous program installation process, but they can use the product flexibly according to need from different working terminals in a manner that suits them. The client software of the product can be run e.g. by plug-ins generally available in an Internet browser.

One advantageous characteristic of the invention is its ability to take into account different points of view associated with persons, organisations or interest groups. In the business development and strategy processes, it is essential to take into account the points of view of different people and interest groups in the processing and consideration of matters. The 3D user interface according to the invention enables linking many points of view visually and functionally to different contexts and emphasizes their significance in the communication of matters. This characteristic provides the necessary conditions for synergistic thinking in an organisation, where the points of view of the other parties are understood in a concrete manner. When everybody is right from one's own point of view, it is essential to be able to form a common idea of the point of view of the organisation as a sum of the different points of view.

Real-time interactiveness in decentralized teamwork is in a general sense communication based on speech, which is intensified by the characteristics of sharing documents and shared views. However, there are few prior art procedures in which capabilities for actual distributed, interactive teamwork have been created.

In addition to simultaneous speech communication of several users, means for resenting and analyzing of ideas are needed in teamwork. The workshop characteristic of the method according to the invention serves this need, creating prerequisites for simultaneous, distributed working of the members of the team also in a visual manner. In addition, an essential characteristic of the method according to the invention is the capability to save the data produced and created during the distributed teamwork for further use.

### BRIEF DESCRIPTION OF THE DRAWINGS

In the following, the invention will be described in more detail with reference to the accompanying drawings, in which

FIG. 1 presents a flow chart of a method according to an embodiment of the invention,

FIG. 2 presents a flow chart of specifying a point of view according to an embodiment of the invention,

FIG. 3a presents a flow chart of specifying an argument template according to an embodiment of the invention,

FIG. 3b presents a flow chart of the use of an argument template according to FIG. 3a,

FIGS. 4a and 4b present a graphical user interface according to an embodiment of the invention,

FIG. 5 presents an arrangement according to an embodiment of the invention,

FIG. 6 presents an electronic device according to an embodiment of the invention, and

FIG. 7 shows the external form of presentation of a user interface according to the invention as a 3D image.

### DETAILED DESCRIPTION

In the following, the operation and different parts of the method and arrangement according to the invention will be described by way of example mostly from the user's point of view. However, it is natural for a person skilled in the art to change the perspective so that an operation described from the user's point of view is converted into the functions of different parts of the system. It is also natural for a person skilled in the art to implement the method steps described as computer code, which can be saved in a suitable electronic device.

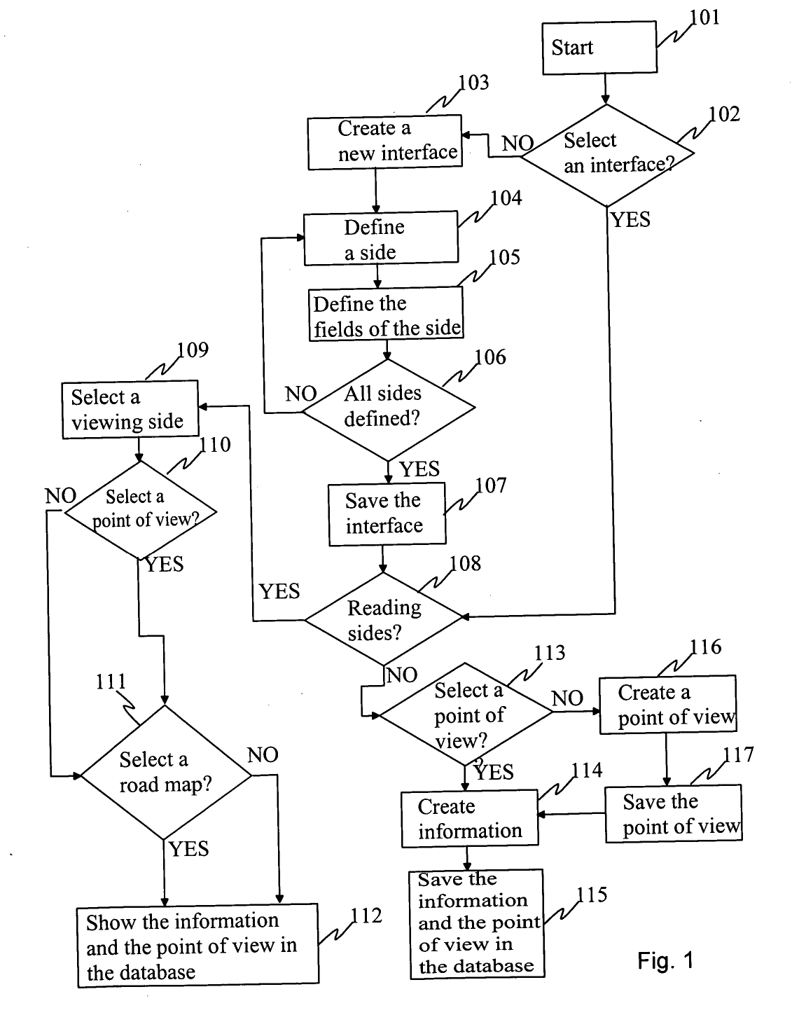

FIG. 1 presents a method according to an embodiment of the invention by means of an exemplary flow chart. The steps of the method can be advantageously implemented as computer program code, for example, which has been saved in the memory of the electronic device.

In step 101, the user starts an application according to the invention in a personal computer, for example. In step 102, the user preferably selects, if it is allowed for the user, a suitable user interface from the saved user interfaces or creates a new user interface in step 103. An example of a situation in which the user cannot select a user interface, is e.g. the procedure for collecting customer feedback, in which the customer can only give the feedback, which is then updated to the system according to the invention.

If the user selects one of the saved user interfaces, the process moves to step 108, in which the application asks the user if he/she wants to read or write information to the database. If the user wants to read information, the process moves to step 109, in which the user selects the viewing side to be presented on the display by means of the 3D user interface. In step 110, the user also selects a point of view, if it is wanted that the information of the viewing side selected is filtered on the basis of a certain point of view. For example, the customer feedback received from the market can be filtered in different ways in different market segments. In practice, filtering by a point of view removes information that does not belong to the selected point of view. So the important characteristics of a certain market segment can be picked up to be used as the starting points of development work.

In addition to the perspectives and points of view, it is also essential to take the time dimension of the objectives, measures and matters into account in the development processes. This time dimension, or roadmap, can be selected by the user in step 111 solely, additionally or alternatively. Combining the roadmap with the perspective enables viewing the strategy over a period of time. The roadmap being dealt with can be divided into four years, for example, which can be viewed either one year at a time or the whole period of four years at a time. The roadmap characteristic delimits the content view in a corresponding way as the point of view. By turning the navigator of the 3D user interface, it is possible to select the period of time to be examined, in which case the material presented in the view is limited to that period of time only. When the selection of the side, point of view and roadmap has been carried out, the application retrieves the information of the selected viewing side and filters the information on the basis of the selected functions, such as the point of view and/or roadmap mentioned above before presenting the information to the user, step 112.

If the user did not select any of the saved user interfaces in step 102, the process moves to step 103, in which the user creates a new user interface. The number of fields of the sides, the names of the sides and the names of the fields of the sides can be edited in the user interface. Web pages can be linked to the sides and the fields of the sides. The number of the sides can be edited according to the number required. In step 104, the side of the user interface is specified by giving the side an identifier, which can be the name given to the side, for example. After this, in step 105, one or more fields are specified on the side and each field is given an identifier and/or name as in the case of the side presented above. From step 106, if more sides are needed, the process moves to step 104, and the steps 104 to 106 are repeated until all the sides required have been specified. After this, the process moves to step 107, where the new user interface is saved in the memory of the computer, e.g. in the memory of a mainframe in a centralized manner. After this, the process moves to step 108.

If the user in step 108 does not only want to read the sides but write to them, the process moves to step 113, in which the user selects a point of view from the points of view saved or creates a new point of view in step 116. If the user selects a point of view from among the saved points of view, the process moves to step 114, in which the user creates the information on the viewing side selected. In this connection, the point of view selected by the user is linked to refer to the information produced. In step 115, the information created by the user is saved, and the point of view associated with it is saved in the database on the viewing side selected.

If the user did not select one of the saved points of view in step 113, a new point of view is created in step 116. The point of view is a personal profile formed by the user or a group profile, which presents the properties of the user or the group, such as age, position in the company, sex and nationality. After this, the new point of view created is saved e.g. in the memory of the server device over the communication network. The creation of the point of view will be described in more detail later.

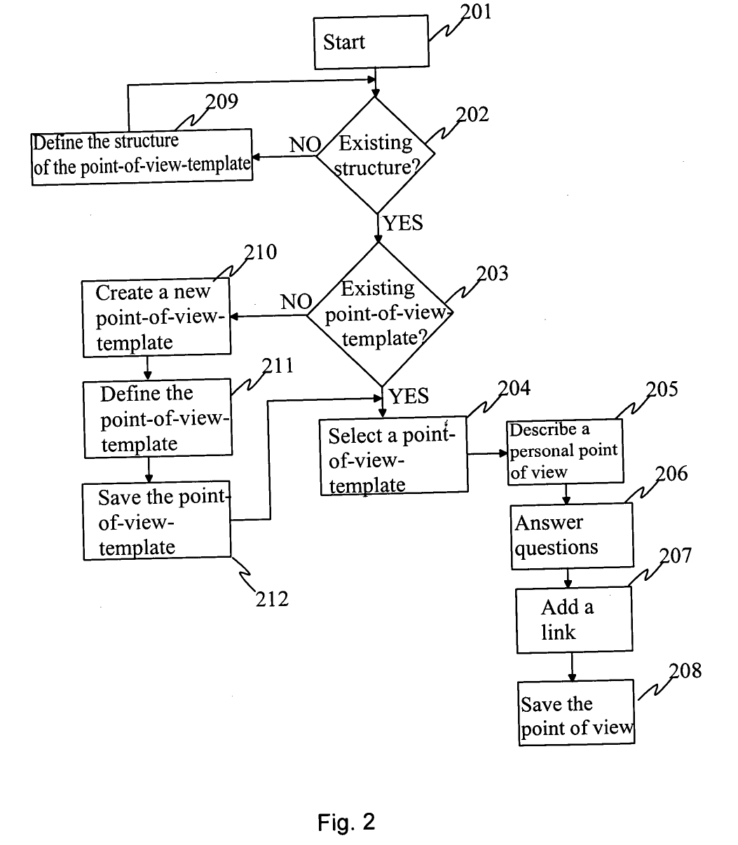

FIG. 2 presents an exemplary flow chart of the definition of a point-of-view-template and a point of view according to an embodiment of the invention. In the step of using, the information to be shown is filtered by the defined point of view. The steps of the method presented in the flow chart can be implemented as a computer program code, for example, which has been saved in the memory of the electronic device.

In addition to the perspectives, in the business development and strategy processes it is essential also to take into account the points of view of the people (personnel) or other target groups. It is possible to create numerous points of view in the tool according to the invention. While the subject and the perspective are specified by the cubic user interface, the navigator, the point of view of the viewers, from which the viewing and commenting of the subject takes place, can be specified by the point-of-view user interface. Along with commenting on matters, the created points of view are linked to the specified perspectives and the themes included in them.

A point of view is a characteristic associated with the users of the arrangement according to the invention. Each user has a point of view either personally or as a group of an organisation. The point of view is described to the system, after which it is always linked to the comments/arguments inputted, and it can be used to filter content views together with the navigator (later also referred to by the term CUBE) of the user interface. As a filtering property, the point of view can be switched on or off. As a linking property, it is always on. With regard to the user interface, it is integrated with the CUBE.

As a linking property, the point of view means that always when the owner of the point of view inputs arguments or comments to the database, the point of view in question is linked to the material inputted. This requires that the owner of the point of view, the user, is identified, and the system knows to which point of view he/she belongs.

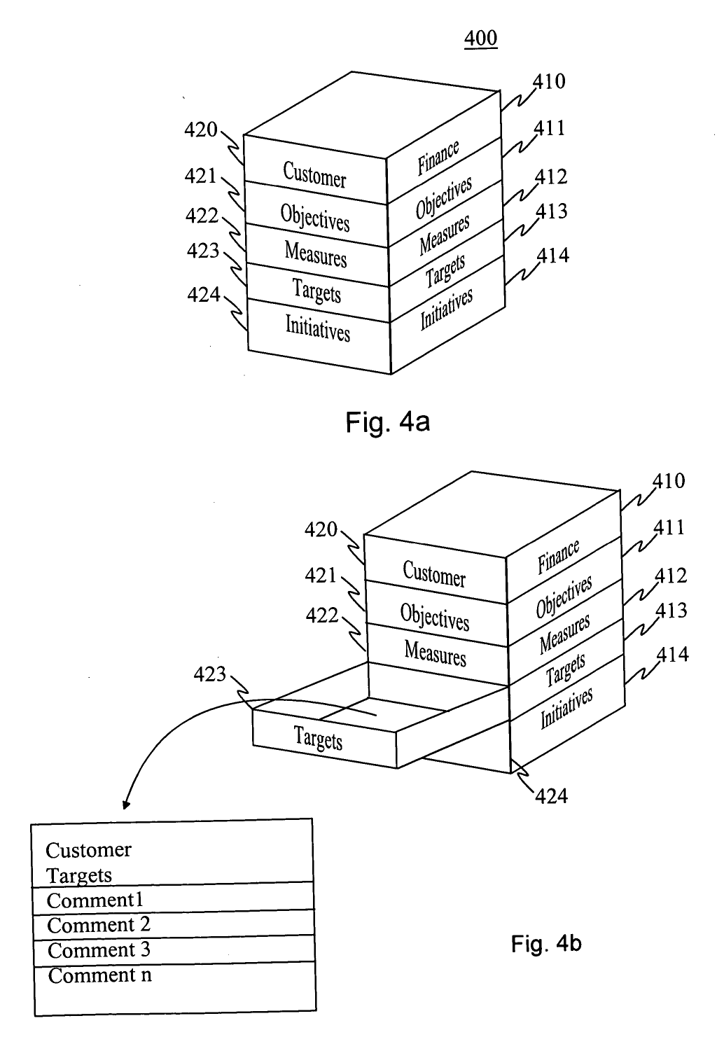

As a filtering property, the point of view means that while the content view is controlled by the CUBE on the level of the perspective, by the point-of-view-filter it can also be controlled on the level of the point of view. When the customer perspective, for example, has been selected from the CUBE, FIGS. 4a and 4b, in which case the whole content related to the customer perspective is shown in the view, the content shown in the customer view can be further limited by selecting some other point of view, which filters out from the customer view the matters that are not related to this other point of view. In addition, the customer perspective can be further divided into different customer or product segments, by which the feedback received from the customers, can be examined in more detail.

In step 201 of FIG. 2, the application according to the invention is started by the user. In step 202 the application asks the user whether he/she wants to use an existing structure of the point-of-view-template, or to define a new structure. If the user wants to use an existing structure, in the next step 203 the user is asked if an existing point-of-view-template will be chosen. If the user selects an existing template, the process moves to step 204. By the point-of-view-template, the user/owner of the point of view can describe the point of view to the system, step 205. The point of view to be created preferably comprises the following kind of information of its user: age, sex and title, cultural background, working community background, organisation, the values or targets of the organisation. Describing this information takes place by answering the questions asked in the template and/or by writing a description to the subjects presented in the template, step 206. The point of view is preferably described in text form. The user can link web links to the description of the point of view by a template, step 207. The description of the point of view is saved in the system when the Save button is pressed, step 208. The text-form description of the owner of the point of view and their set of values is linked to the comments/arguments when they are inputted, and it filters the content views created like this. With regard to the user interface and graphically, the point of view is integrated into the user interface so that the idea of looking at things through a point of view is emphasized. The administrators have the possibility of creating a view in which they can browse all the points of view described in the database.

If there was no existing structure in step 202, the process moves to step 209, in which the structure of the point-of-view-template is defined. The points of view are described to the database with a template created for the purpose. A template is created for this purpose by the point-of-view-editor within the scope of a predetermined structure. The editor can also be used to change, remove or add a point-of-view-template created earlier.

If the user does not want to use an existing point-of-view-template in step 203, the process moves to step 210, in which a new point-of-view-template is created. In step 211, a new point-of-view-template is defined, and finally in step 212, a new point-of-view-template is saved in the memory of the computer, for example.

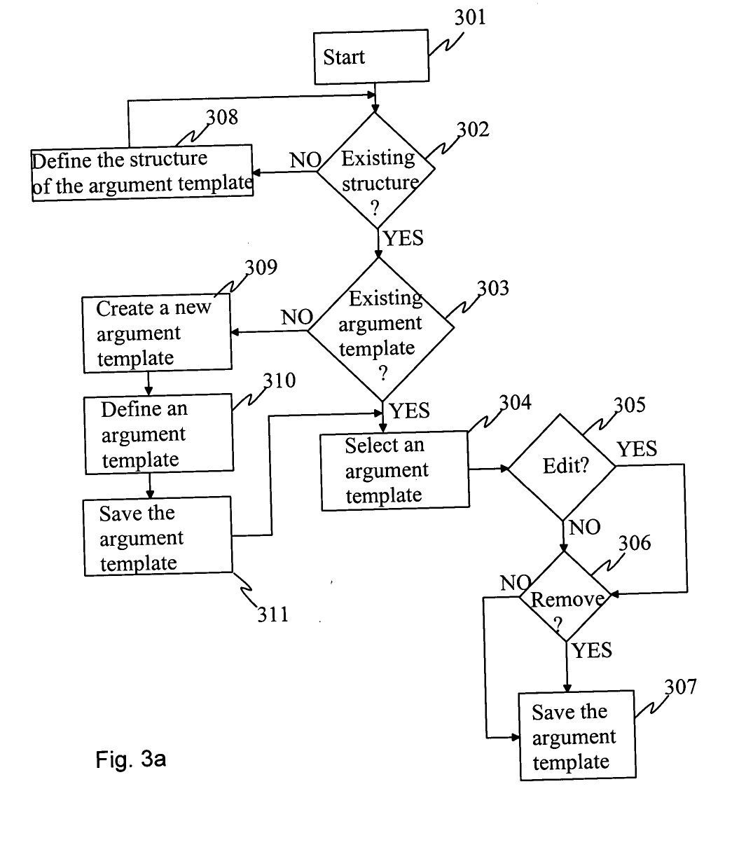

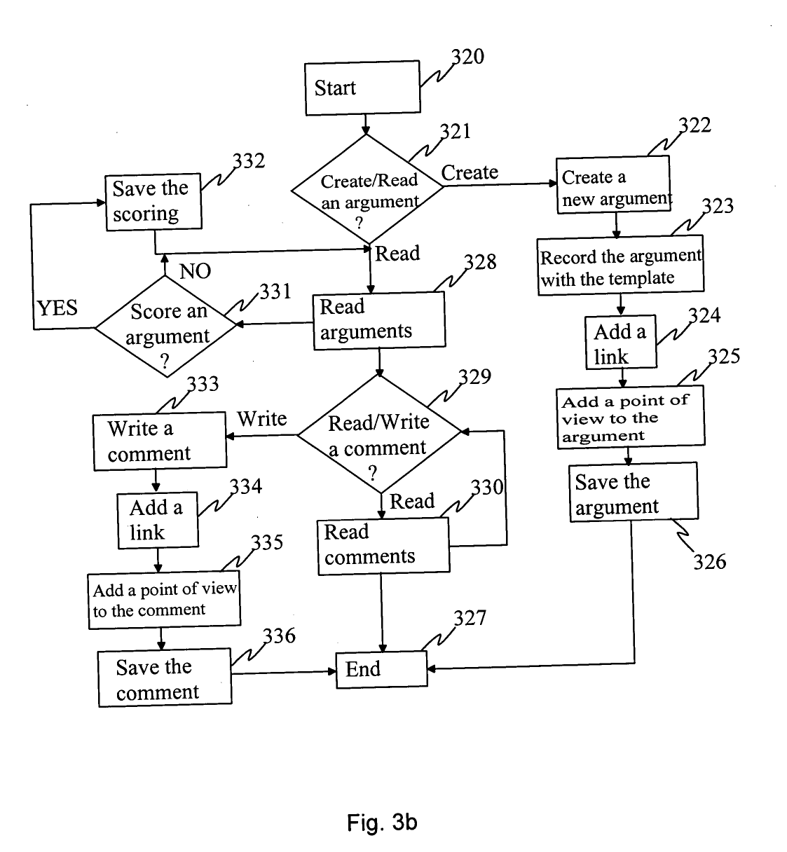

FIG. 3a presents an exemplary flow chart of defining an argument template according to an embodiment of the invention; the steps of the method can be implemented as computer program code, for example, which has been saved in the memory of the electronic device.

In step 301, the user starts an application according to the invention. In step 302, the user is asked if an existing structure of an argument template is used or not. The argument template is used to describe or record the arguments related to each perspective of the CUBE (process) and their themes to the system according to the invention. The arguments are defined in the template to concern a certain period of time. In addition, the arguments are linked to the user's point of view. The arguments of the argument template are saved in the system, and they are presented in a view, which is controlled by the CUBE. The arguments can be commented on in the view. If the user does not want to use an existing structure, the process moves to step 308, in which the user defines the structure of the new argument template. If it is decided in step 302 that an existing structure is used, the next step is 303, in which the user is asked whether he/she wants to use an existing argument template or create a new template. If the user answers yes in step 303, the process moves to step 304, in which the user selects the desired argument template. The user can edit, step 305 and/or remove the template, step 306, and save the changes made in the template, step 307.

If the user wants to create a new argument template in step 303, the process moves to step 309. The argument template is defined next in step 310. The arguments are preferably recorded in text form. Web links can be advantageously linked to the arguments by the template. The arguments are saved in the system e.g. when the Save button is pressed, step 311.

FIG. 3b presents an exemplary flow chart of the use of an argument template according to FIG. 3a, The steps of the method can be implemented as computer program code, for example, which has been saved in the memory of the electronic device.

In step 320, the user starts an application according to the invention. The user can create or read arguments, step 321. If the user creates a new argument, step 322, the arguments are recorded in the system by means of templates created for them, step 323. These templates are created by the argumentation editor within the predetermined structure. In addition, it is possible to add to the argument a link, step 324, and a point of view, step 325, and finally the argument is saved in the system in step 326. The application is ended in step 327.

If the user wants to read the arguments, step 328, they can score the argument read, step 331, which scoring is saved in the system in step 332 either by the user or by the system. Besides commenting, the user is preferably given a change to prioritize/evaluate the arguments by scoring them like in a poll. Furthermore, the user has preferably a possibility to link files and documents, in addition to web pages, to the comments, arguments and points of view.

The arguments and comments are read in steps 329-330. The user can comment on the arguments in step 333, which takes place in a text-based manner through the user interface. The user can also attach links, such as web links, step 334, and a point of view, step 335, to the comments. The material inputted to the system by argumentation templates is presented in a content view, which is delimited and controlled by the user interface and the roadmap. The perspective and/or theme to be presented and the period of time concerned are then selected. In connection with each argument, there is an openable window in which the point of view of the inputter of the argument is presented. If the point-of-view-filter is on, the material to be presented is limited according to the point of view chosen.

Presenting the arguments is based on a view of the type and functionality of a discussion forum. When the user reads the argument, he/she can comment on the argument set forth by opening the Commenting window. The structure of the commenting is free. When the user saves the comment, it is saved hierarchically and becomes linked with the argument. After this, the user can read the argument and the comments made on it. The point of view of the commentator is automatically linked to the comment, which makes it possible to check, when reading the comment, from which point of view it has been made. In the comment window, the user can add a web link to a text-form comment when desired. The web links added to the arguments, points of view and comments can be opened by pressing the www-button.

In step 336, the comment is saved in the system, such as a centralized database, and the application can be ended, step 327.

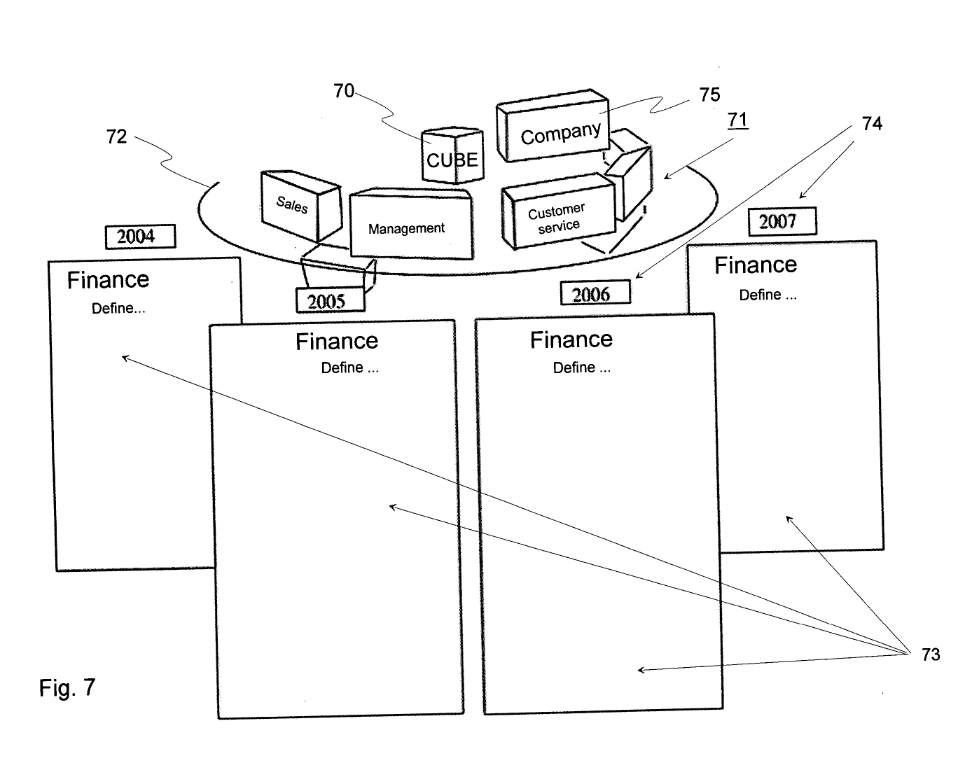

The graphical 3D user interface according to an embodiment of the invention, the CUBE, is shown by way of example in FIGS. 4a and 4b. The user interface according to the invention is a three-dimensional navigator, which emphasizes the concept “it depends on where you look from”. The graphical, interactive user interface organises visually the points of view being examined, and by it the user can control the content views. The user can bring out the desired perspective by turning the navigator. The point of view to be examined, on the basis of which the views are dynamically formed, is then selected by the navigator. The concept “it depends on where you look from” offered by the user interface helps to understand different points of view and to emphasize matters in the right way. This way of thinking and presentation is further illustrated by the example of FIG. 7.

A plurality of separate monitors is used in another embodiment of the invention. Then the desired content views can be shown in different monitors at the same time. This is advantageous e.g. when the user wants to examine the information/feedback of different customer or product sectors at the same time.

In addition to being able to look at matters from different points of view, the possibility to crystallize and simplify matters is an essential capability. The desired perspective for processing is selected by turning the cube. For example, in the Balanced Scorecard model the perspective can be selected from the following: Customer, Process, Competence or Finance. Each of these perspectives can be advantageously divided into a number of themes, which, in the case of Balanced Scorecard can be, for example: Objectives, Measures, Targets and Initiatives. By the user interface according to the invention, the existing material is then presented in accordance with the selections made by the user. Other examples of possible applications are the development of the strategy of a new, starting company or the management of the product development process when a new product is being launched on the market.

The cubic user interface, the CUBE, is used both for defining the arguments of the perspectives, strategy work, and for presenting the arguments, communication of the strategy. The activated field of the side selected by the user is “zoomed” visible at a readable “distance” as presented in FIG. 4b.

The exemplary user interface presented in the following for illustrating the invention is built of four sides, which are divisible into four fields. One side defines one perspective. The sides are divisible into fields, which define the themes to be dealt with. The CUBE can be turned horizontally, and the side or field wanted by the user can be selected from it.

The user interface 400 according to the example is built in the following manner when the Balanced Scorecard method, for example, is utilized. The first side of the user interface according to the invention, FINANCE 410, has preferably the following contents. It preferably comprises, as seen from the point of view of finance, the target field 411, the measure field 412, the development target field 413 and the initiative field 414. The second side of the user interface, CUSTOMER 420, comprises, as seen from the customer's point of view, the target field 421, the measure field 422, the development target field 423 and the initiative field 424. In addition, this customer field can be further divided on the basis of either the customer or product segments. In the method according to the invention, the feedback saved in these fields is entirely real-time.

In addition, the exemplary user interface of FIG. 4a comprises sides 3 and 4, which are not shown in the figure. Side 3 comprises, as seen from the point of view of the process, the target field, the measure field, the development target field and the initiative field. Side 4 comprises, as seen from the competence point of view, the target field, the measure field, the development target field and the initiative field.

As was mentioned earlier, the user interface according to the invention is not limited to the forms or the number of sides presented above. There can be more or less sides or fields on each side in the 3D user interface than what was presented above. Instead of the cube or beside it is possible to use a number of separate monitors. The user interface can naturally also be applied to other business development processes than Balanced Scorecard, which was mentioned as an example above.

The next step is to hold a simultaneous session over the network for a plurality of users according to the invention, in which it is possible to present arguments and comments and to analyze the arguments and comments visually.

The basic functionality of the user interface is of asynchronic nature, i.e. communication taking place at different times, geographically distributed, which is supported by all the characteristics mentioned above in their basic functionalities. However, the Workshop characteristic creates a possibility to use the user interface also in simultaneous, geographically distributed communication. The purpose is not to create a system that would replace the existing collaborative software. It is more like supporting them, creating a possibility for visual communication of the blackboard type and for analyzing matters. The material thus created can be saved in the system according to the invention through the user interface.

When participating in a Workshop type session, the users can add and move ‘post-it’ slips on a common roadmap table and write arguments on the slips, and preferably evaluate the slips/arguments by voting. The Workshop characteristic can be limited to concern the functionality of the argumentation template, in which case arguments can be placed in it for the selected period of time in the blackboard manner. The Workshop characteristic can naturally also be implemented in connection with other characteristics.

The arguments/post-it slips processed during the Workshop can be selected for saving, and at the end of the session, the selected slips can be saved in the system by the session manager in a similar manner as saving by argumentation templates.

The implementation of closed dialogues as part of the workshop characteristic can be carried out in the following manner, for example. In a closed dialogue, two or more participants of the session can switch temporarily to a closed connection, from which they can again return to the connection open to all the participants of the session. This workshop characteristic is supported by the following sub-characteristics that belong to this characteristic.

During the workshop, one user operates as the session manager, in which case he/she has the administrator's rights of use. The session manager can freeze the points of view and themes of the session and interrupt the session when required. Through a message window, the session manager can present commands and comments to other users during the session.

A part of the workshop characteristic is the message window according to the invention, through which the participants of the session can freely discuss in text form and/or give advice to other participants of the session.

By the collection view it is possible to output the material inputted to the system in other ways. For example, it can be used to collect all the comments together. In accordance with individual parameters, all the material inputted according to the parameter in question, e.g. all the comments or all the arguments or all the points of view can be outputted to the collection views.

The proceeding view of the process presents the progress of the process in an illustrative manner. The purpose of the view is also to illustrate the present state of the process. It presents a description of the steps of the process carried out and not carried out.

It is also possible to transfer the material inputted to the system according to the invention for further processing in the file formats of MS Office and/or Adobe PDF, for example. In that case, the material inputted to the system is outputted as off-line files, which are preferably taken to the programs of the Microsoft Office tool family and/or used as Adobe Portable Document Format (PDF) files in situations in which no network connection is available.

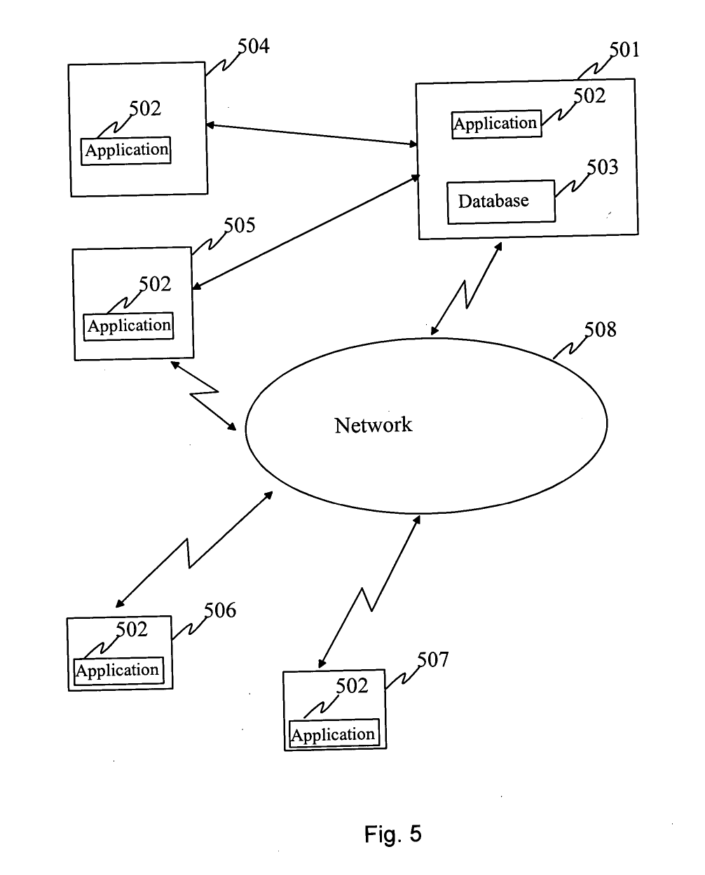

FIG. 5 shows, by way of example, an arrangement 500 according to an embodiment of the invention. The arrangement comprises a server device 501, which further comprises an application 502 for implementing the methods according to the invention, and a database 503 for saving the information. Advantageously, the application 502 comprises the procedures described in connection with FIGS. 1 to 3b, and the database 503 the information presented in connection with the description of FIGS. 4a and 4b. In addition, the arrangement comprises stationary computers, such as PC desktop computers, references 504 and 505, and mobile terminal devices, references 506 and 507, such as portable PCs, palm computers or other mobile communication devices.

The devices 504 and 505 communicate with the server device 501 along a fixed network connection, such as the intranet of a company. The devices 506 and 507 communicate with the server device 501 via the communication network 508. The devices 504 and 505 are also capable of communicating via said network with the server device 501.

The devices 504 to 507 also comprise said application 502. Alternatively, the application can be located only on the server device 501, in which case using the application takes place via the communication network 508.

The user of each device, references 501, 504-507, is capable of using the application according to the invention in the manner described above, depending on their rights of use. Thus a user belonging to a customer interest group, for example, can just save their evaluations and arguments in the system. The formed comments and arguments are saved in the database together with information referring to them, such as the points of view.

The functionality of the method according to the invention over a communication network results in fast and cost-effective operation. Thus, for example, travelling is reduced in geographically distributed organisations.

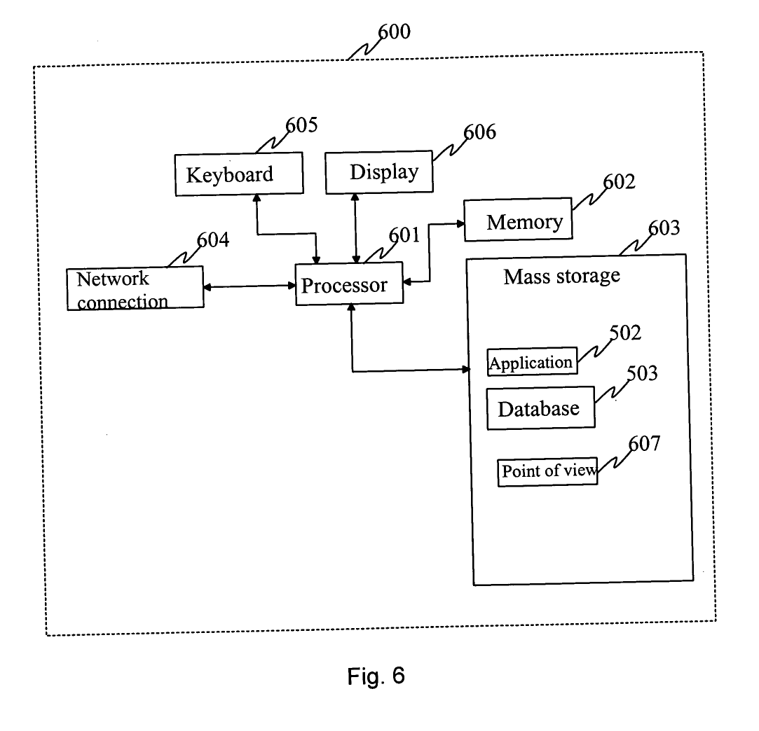

FIG. 6 shows, by way of example, an electronic device 600 according to an embodiment of the invention. The device is preferably the server device 501 presented in the embodiment of FIG. 5. The device 600 comprises preferably a processor 601, a memory 602 for carrying out the functions of the device, a mass storage 603 for saving information and applications, such as the application 502 implementing the method according to the invention, a database 503 and information, such as the points of view 507. The device 600 also comprises a network connection for transferring information over the communication network to other electronic devices and backwards from them. The device also comprises a keyboard 605 for inputting information to the memory of the device, and a display 606 for displaying information and, for example, the three-dimensional user interface according to the invention on the display of the device 600. In a preferred embodiment of the invention, the information/views comprised by the arrangement can be presented on a plurality of separate monitors simultaneously.

FIG. 7 shows one example of what the 3D user interface according to the invention looks like on the display of some electronic device. The drawing presents a certain company, ref. 75. In the example of FIG. 7, separate boxes 71 describing different functions have been added beside the cube shown in FIGS. 4a and 4b, the CUBE. In the example of FIG. 7, the boxes 71 selected as examples illustrate customer service, management and sales. The number of boxes 71 is not limited to the number shown in the figure, but a required number of them can be created. The function, i.e. the function/box/part of organisation, which the user wants to examine in the example of FIG. 7, is advantageously brought out by turning an imaginary circle 72. Turning the circle 72 can be carried out by a mouse belonging to the electronic device or by suitable keyboard commands.

When the desired function has been brought out, a process can be selected from it for examination. In the same procedure it is possible to select a certain point of view 73, by which the information in the system is wanted to be filtered. In the example of FIG. 7, Finance 73 has been selected as the point of view to be used in the viewing. In the example of FIG. 7, the time dimension 74 has been used as an additional point of view. Thus the matters thought to be important for the years 2004 to 2007 can be seen as year-specific presentations. After the selection of the point of view has been made, the year-specific presentations include information related to finance.

The implementation and embodiments of the invention have been described here in the light of examples. It is clear to a person skilled in the art that the invention is not limited to the details of the embodiments described above, and that the invention can also be implemented in some other form without departing from the characteristics of the invention. The embodiments presented should be regarded as enlightening, but not limiting. Thus the possibilities of implementation and use of the invention are limited only by the accompanying claims. Therefore, the different alternative embodiments of the invention defined in the claims, including equivalent embodiments, fall within the scope of the invention.

1. A method for filtering information and presenting the filtered information in an electronic information system, the method comprising the steps of:
conveying information to a database included in the electronic system;
saving the information produced/processed by information creators in a centralized manner;
selecting by using a graphic 3D user interface a viewing side and a point of view used in examining the side, which point of view specifies at least one characteristic of a user of the information;
retrieving the information of the selected viewing side from the database, and filtering said information on the basis of the point of view selected by the user;
linking the filtered, retrieved information of the database to at least two different viewing sides of the graphic 3D user interface;
presenting by the graphic 3D user interface the retrieved information on at least two different viewing sides to the user.

2. The method according to claim 1 wherein the user also selects a roadmap period of time for filtering the information of said viewing side.

3. The method according to claim 1 wherein the method further comprises a step for defining a point-of-view-template for forming a point of view.

4. The method according to claim 3 wherein said point of view is formed by defining by the user at least one of the following characteristics by using the point-of-view-template: age, sex, title, cultural background, working community background, organisation, the values or targets of the organisation.

5. The method according to claim 3 wherein the method further comprises a step for linking said point of view with the information formed by the user and to be saved in the database.

6. The method according to claim 1 wherein conveying the information to the database comprises real-time customer feedback given in electronic form.

7. An electronic information system for filtering information before showing it, the information system comprising:
a means for conveying information to a database by a creator;
a means for saving the information produced/processed by the creators in the database in a centralized manner;
a means for forming a point of view in the information to be saved in the database, which point of view specifies at least one characteristic of the creator of the information;
a means for retrieving the saved information of the selected viewing side from the database;
a means for filtering said retrieved information on the basis of a point of view selected by a user;
a means for offering at least one viewing side and at least one point of view to the user by means of a graphic 3D user interface, and
a means for linking the filtered information retrieved from the database on at least two different viewing sides on the 3D user interface.

8. The information system according to claim 7 wherein the information system further comprises a means for forming a roadmap period for the purpose of filtering the information of said retrieved viewing side on the basis of said roadmap period.

9. The information system according to claim 7 wherein the information system further comprises a means for defining a point-of-view-template for forming a point of view.

10. The information system according to claim 9 wherein said offering means further define a point of view on account of an input given by the user using said point-of-view-template on the basis of at least one of the following characteristics: age, sex, title, cultural background, working community background, organisation, the values or targets of the organisation.

11. The information system according to claim 10 wherein the system further comprises linking means for linking said point of view to the information formed by the creator and to be saved in the database.

12. The information system according to claim 7 wherein the means for recording the information in the database further comprise a means for recording real-time customer feedback given in electronic form.

13. A computer program product for filtering information before showing it in an electronic device, the computer program product comprising:
a computer-readable code means for forming a point of view in the information to be saved in the database, which point of view specifies at least one characteristic of a creator of the information;
a computer-readable code means for selecting a viewing side by means of a graphical 3D user interface by a user;
a computer-readable code means for retrieving the information of the selected viewing side from the database;
a computer-readable code means for linking the information to be retrieved from the database to at least two different viewing sides in the graphical 3D user interface;
a computer-readable code means for filtering said information to be retrieved on the basis of a point of view selected by the user, and
a computer-readable code means for offering at least one viewing side filtered by the point of view to the user through the graphical 3D user interface.
